(19) United States
(12) Patent Application Publication
(10) Pub. No.: US 2026/0070745 A1
(43) Pub. Date: Mar. 12, 2026

(54) METHOD AND STORAGE SYSTEM FOR MANAGING CONTAINER

(71) Applicant: ABB SCHWEIZ AG, Baden (CH)

(72) Inventors: Haoteng Lei, Shanghai (CN); Jianqiang Jia, Shanghai (CN); Bojun Ma, Shanghai (CN); Yin Tian, Shanghai (CN)

(21) Appl. No.: 19/384,611

(22) Filed: Nov. 10, 2025

Related U.S. Application Data
(63) Continuation of application No. PCT/CN2023/093937, filed on May 12, 2023.

(51) Int. Cl. B65G 47/90; B25J 9/00; B65G 1/137; B65G 60/00; B65G 61/00

(52) U.S. Cl. CPC B65G 47/902; B25J 9/0093; B65G 1/1378; B65G 60/00; B65G 61/00; B65G 2814/0304

(57) ABSTRACT

Embodiments of present disclosure relates to a method of managing a container for storing products including: obtaining a type of the container on a conveyor line; determining, based on the determined type, for the container, a target storage position on a circumferential shelf, wherein the circumferential shelf includes a plurality of storage racks arranged in a circumferential shape, a storage rack includes a plurality of storage compartments arranged in multiple layers, and a storage compartment includes at least one storage position for storing at least one container; and actuating, based on the determined target storage position, a rotatable effector located inside the circumferential shelf to transfer the container to the target storage position.

### FIELD

Embodiments of the present disclosure generally relate to a storage system employing an industrial robot, more particularly to a method and a system for managing a product container by using the industrial robot.

### BACKGROUND

For chain supermarkets, convenience stores and the like, there is a common link of centralized production, sorting, packing and distribution. Because the quantity required by each store is usually of small batch and multi-variety, this link involves multiple packing of various inventory quantities. This scenario usually requires a lot of labor. Moreover, the working environment is usually poor, such as a cold storage room with temperature of 0 to 4 degrees. Therefore, the demand for automation is urgent. It is a more feasible way to use robots cooperating with grippers to implement automatic sorting, packing and so on.

Based on this, retail warehouse urgently needs to use automation upgrading to improve efficiency, expand business capabilities, and achieve the goal of cost reduction and efficiency increase, and improve the quality of logistics supply chain.

### SUMMARY

Example embodiments of the present disclosure provide a method and a system of managing a container for storing products, which can achieved high flexibility, small floor area, flexible and expandable, short deployment cycle, improved space utilization, and the integrated design of workstations of robots.

In a first aspect of the present disclosure, it is provided a method of managing a container for storing products comprising: determining a type of the container on a conveyor line; determining, based on the determined type, a target storage position for the container on a circumferential shelf, wherein the circumferential shelf comprises a plurality of storage racks arranged in a circumferential shape, a storage rack among the plurality of storage racks comprises a plurality of storage compartments arranged in multiple layers, and a storage compartment among the plurality of storage compartments comprises at least one storage position configured to store at least one container; and actuating, based on the determined target storage position, a rotatable effector located inside the circumferential shelf to transfer the container from the conveyor line to the target storage position.

By the above mentioned method, the storage system can solve the limitations of current robot totes stacking process, adapt to complex stacking types, factory environment and various needs, and achieve an efficient collaborative integrated intelligent retail warehouse solution for stacking totes using industrial robots. Specifically, the storage system includes a cooperation of robot (for example, a 6-axis industrial robot) with circumferential warehouse shelf, and the robot is responsible for the storage and scheduling of totes, and the circumferential warehouse shelf is arranged in a compact and reasonable ring or circular layout and may save storage space and improve storage efficiency.

In some embodiments, the type of the container is determined based on a type of the products stored in the container. In this way, all containers used in this storage system can be of same shape regardless of the types of the containers, such that only one effector can handle different types of containers for storing different types of products.

In some embodiments, the container comprises one container, or the container comprises a set of containers for storing same type of products, the set of containers are stacked together, a number of the set of containers is less than or equal to a maximum number of containers that can be accommodated per storage compartment. In some embodiments, determining, based on the determined type, the target storage position for the container on the circumferential shelf comprises: determining predetermined storage positions on the circumferential shelf that are predefined for containers of the determined type; obtaining a occupancy status of the predetermined storage positions; determining, based on the occupancy status, a plurality of free storage positions among the predetermined storage positions; and selecting a set of free storage positions among the plurality of free storage positions as target storage positions for a corresponding number of containers. In this way, the loading (for example, stacking and unpacking mechanism) mechanism can stack the same type of containers together the robot may put a stack of totes onto the shelf, and a single material tote flows away directly., and thus the system can realize the inbound operation of totes and incoming material combination with high efficiency. When the warehousing quantity is large, several totes can be warehoused together to improve the storage efficiency.

In some embodiments, the container comprises a set of containers for storing different types of products, the set of containers being stacked together, a number of the set of containers being less than or equal to a maximum number of containers that can be accommodated per storage compartment, and determining, based on the determined type, the target storage position for the container on the circumferential shelf comprises: obtaining a occupancy status of the circumferential shelf; determining, based on the occupancy status, a plurality of free storage positions; selecting a set of free storage positions among the plurality of free storage positions as a set of preliminary target storage positions for the set of containers; obtaining the type of a target container located at a certain preliminary target storage position among the set of preliminary target storage positions; and determining, based on the determined type of the target container, an updated target storage position of the target container on the circumferential shelf. In some embodiments, actuating, based on the determined target storage position, the effector located inside the circumferential shelf to transfer the container to the target storage position comprises: based on the set of preliminary target storage positions, actuating the effector to move the set of containers to the set of preliminary target storage positions; and based on the determined updated target storage position, actuating the effector to move the target container among the set of containers from the certain preliminary target storage position to the updated target storage position. In some embodiments, determining, based on the determined type of the target container, the updated target storage position of the target container on the circumferential shelf comprises: determining predetermined storage positions on the circumferential shelf that are predefined for containers of the determined type; obtaining a occupancy status of the predetermined storage positions; determining, based on the occupancy status, a free storage position among the predetermined storage positions; and selecting the determined free storage position as the updated target storage position for the target container.

In this way, for peak business and idle time, by stacking various different types of containers together and storing them as whole into the shelf and then sorting them out at night by the flexible gripper, the system not only meets the normal operation of multiple peaks, but also ensures the utilization of idle time. Therefore, this design scheme has strong freedom and flexibility, achieving high throughput, high flexibility. Warehouse efficiency has been significantly improved, and labor and material costs has been reduced significantly.

In some embodiments, the target container is located at a storage position other than a top storage position of the preliminary target storage positions, and the effector comprises a plurality of actuation mechanisms, wherein based on the determined updated target storage position, actuating the effector to move the target container among the set of containers from the certain preliminary target storage position to the updated target storage position comprises: actuating a first actuation mechanism of the plurality of actuation mechanisms to lift one or more containers above the target container; actuating a second actuation mechanism of the plurality of actuation mechanisms to pick the target container; actuating the first actuation mechanism to place the one or more containers to respective preliminary target storage positions; and actuating the second actuation mechanism to transfer the target container from the certain preliminary target storage position to the updated target storage position.

In this way, the intelligent sorting fixture or gripper of the robot has multi-layer grippers, and by actuating different grippers to move in the up and down direction and forward and backward direction, the grippers may grip different containers at different storage positions, even at middle storage positions. Thus, the system may realize sorting of any stacked totes in the shelf according to any specific requirements, etc. It has faster sorting speed and strong flexibility and adaptability.

In some embodiments, the method further comprises determining a storage position of an outbound container; and actuating the effector to transfer the outbound container from the determined storage position onto the conveyor line. In some embodiments, the effector comprises a plurality of actuation mechanisms and the outbound container is located at a storage position other than a top storage position of a respective storage compartment, wherein actuating the effector to transfer the outbound container from the storage position onto the conveyor line comprises: actuating a first actuation mechanism of the plurality of actuation mechanisms to lift one or more containers above the outbound container; actuating a second actuation mechanism of the plurality of actuation mechanisms to pick the outbound container; actuating the first actuation mechanism to place the one or more containers into the respective storage compartment; and actuating the second actuation mechanism to transfer the outbound container from the storage position onto the conveyor line. In some embodiments, the effector comprises a plurality of actuation mechanisms, and the outbound container comprise a plurality of outbound containers belonging to different types, and actuating the effector to transfer the outbound container from the storage position onto the conveyor line comprises: actuating a first actuation mechanism of the plurality of actuation mechanisms to pick a first set of outbound containers belonging to a first type of the different types ; actuating a second actuation mechanism of the plurality of actuation mechanisms to pick a second set of outbound containers belonging to a second type of the different types; and actuating the plurality of actuation mechanisms to transfer the plurality of outbound containers to the conveyor line.

In this way, the intelligent sorting fixture or gripper of the robot has multi-layer grippers, and by actuating different grippers to move in the up and down direction and forward and backward direction, the grippers may grip different containers at different storage positions, even at middle storage positions. Thus, the system may realize outbound delivery of any tote in the shelf according to any specific order, or achieve combined outbound any totes in the shelf according to any specific combinations etc. Any combination of stock out is allowed. Any one tote or several totes on the upper layer can be delivered flexibly. It has faster outbound delivery speed and strong flexibility and adaptability.

In some embodiments, the effector comprises a robot located inside the circumferential shelf. Compared with a forklift used in the current storage system, the industrial robot has more flexibility and more adaptability.

In a second aspect of the present disclosure, it is provided an electronic device comprising: a processor; and a memory coupled to the processor and comprising instructions that when executed by the processor, cause the processor to perform the method according to the first aspect of the present disclosure.

In a third aspect of the present disclosure, it is provided a storage system comprising: a container for storing products, wherein a type of the container is determined based on the type of the products stored therein; a circumferential shelf comprising a plurality of storage racks arranged in a circumferential shape, wherein a storage rack among the plurality of storage racks comprises a plurality of storage compartments arranged in multiple layers, and a storage compartment among the plurality of storage compartments comprises at least one storage position for storing at least one container; a conveyor line located at an opening arranged on the circumferential shelf and configured to convey the container into or out of the circumferential shelf; a rotatable effector located inside the circumferential shelf and configured to be actuated to transfer the container from one of the conveyor line and the circumferential shelf to the other of the conveyor line and the circumferential shelf; and an electronic device according to the second aspect of the present disclosure.

In some embodiments, the conveyor line comprises: an inbound mechanism located at the opening and configured to convey the container towards the circumferential shelf; an outbound mechanism located at the opening and configured to convey the container towards the conveyor line; a container type identification mechanism located at the inbound mechanism and configured to identify a type of the container; and a container loading mechanism for stacking and unpacking a set of containers on the inbound mechanism.

In a fourth aspect of the present disclosure, it is provided a computer readable storage medium comprising instructions stored thereon, which when executed on at least one processor, cause the at least one processor to perform the method according to a first aspect of the present disclosure.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 illustrates a perspective view of a storage system according to some embodiments of the present disclosure;

FIG. 2 illustrates a plan view of a storage system according to some embodiments of the present disclosure;

FIG. 3 illustrates a flow chart of managing the product container according to some embodiments of the present disclosure;

FIG. 4 illustrates a perspective view of a flexible gripper of the robot according to some embodiments of the present disclosure; and

FIG. 5 illustrates a perspective view of a flexible gripper of the robot and the containers housed therein according to some embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that may be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the Figures. Other definitions, explicit and implicit, may be included below.

As mentioned above, for chain supermarkets, convenience stores and the likes, there is a common link of centralized production, sorting, packing and distribution. Because the quantity required by each store is usually of small batch and multi-variety, this link involves multiple packing of various inventory quantities. This scenario usually requires a lot of labor. Moreover, the working environment is usually poor, such as cold storage room of temperature from 0 to 4 degree. Therefore, the demand for automation is urgent. It is a more feasible way to use robots cooperating with grippers to implement automatic sorting, packing and so on.

In the current robot storage system, in order to save space and standardize management, the product containers (such as totes) in retail warehouses are stored in stacks. The retail warehouse includes a plurality of shelfs, and the shelfs are arranged row by row, and the carrier robot may enter a gap between shelfs of adjacent rows so as to pick up the target or required tote. Sometimes, the totes need to be frequently put in and out of the warehouse according to orders. Sometimes, the frequency of totes put in and out of the warehouse is too low to match the picking frequency of the carrier robot, which leads to the problem of low frequency or high cost of the entire system. In addition, due to low space utilization rate (for example, shelfs arranged row by row) and low storage density in the picking area (for example, large gap between adjacent shelfs available for the carrier to move through) in the current storage system, based on the simple structure of current storage robot (for example, a forklift with a gripper) and the limitation of warehouse layout, it is unable to adapt to frequent inbound and outbound and flexible scheduling (such as obvious peaks and troughs and unbalanced operations), and there are obvious efficiency problems.

In view of the above, the present disclosure proposes a storage system which may solve the limitations of current robot totes stacking process, adapt to complex stacking types, factory environment and various needs, and achieve an efficient collaborative integrated intelligent retail warehouse solution for stacking totes using industrial robots. Specifically, the storage system includes a cooperation of robot (for example, a 6-axis industrial robot) with circumferential warehouse shelf, and the robot is responsible for the storage and scheduling of totes, and the circumferential warehouse shelf is arranged in a compact and reasonable ring or circular layout and may save storage space.

Hereinafter, a storage system 100 for managing (for example, inbound storage, sorting, and outbound delivery) product container will be described in details.

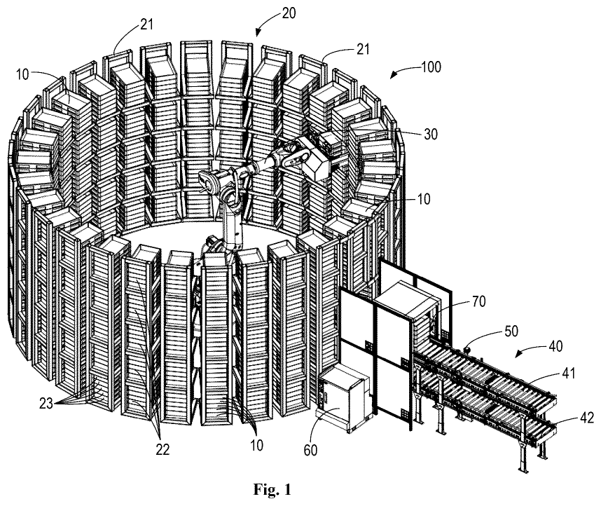

As shown in FIG. 1, the storage system 100 comprises a set of containers 10 (such as totes, trays, cartons, plastic boxes and the like) suitable for storing products; and a circumferential shelf 20 for housing the set of containers 10. Although the circumferential shelf 20 is of a ring shape as shown in FIG. 1, it should be understood that the circumferential shelf can be any other shape that can surround an effector 30 described hereinafter, for example, an oval shape, a rectangle shape, a quasi-ring shape and the like.

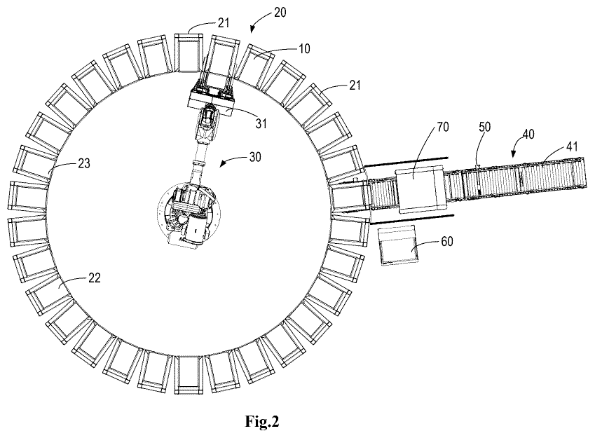

In some embodiments, as shown in FIG. 1 and FIG. 2, the containers 10 for storing different types of products are of same shape such that several containers 10 may be stacked together so as to save the storage space. The container 10 may be made from any suitable material. Warehousing totes can be of the same type or different types, and different types refer to the types of materials in totes, not different shapes of totes.

As shown in FIG. 1 and FIG. 2, the circumferential shelf 20 includes a plurality of storage racks 21 arranged in a circumferential shape, and each storage rack 21 includes a plurality of storage compartments 22 arranged in multiple layers, and the storage compartment 22 in each layer includes at least one storage position 23 for storing at least one container 10. For example, the storage compartment 22 in each layer may include five storage positions stacked one over another, and thus can house up to five containers 10. However, it should be understood that the maximum number of storage positions in the storage compartment in each layer may be any other numbers as required. Comparted with the current warehouse shelfs arranged row by row, the circumferential shelf 20 may save floor area ratio by at least 10% to 30%.

As shown in FIG. 1 and FIG. 2, the storage system 100 further includes the effector 30 (such as a 6-axis industrial robot) disposed inside the circumferential shelf 20, and preferably, in a center of the projection onto the ground of the circumferential shelf. The effector 30 is rotatable, such that an end effector (such as a flexible gripper) may achieve each storage position on the circumferential shelf 20. As shown in FIG. 1 and FIG. 2, the effector 30 is controlled by a controller 60. The controller 60 may communicate with the effector 30 so as to transmit control signal to the effector 30.

As shown in FIG. 1 and FIG. 2, the storage system 100 further includes a conveyor line 40 including an upper conveyor line 41 acted as an inbound mechanism and a lower conveyor line 42 acted as an outbound mechanism. That is to say, the upper conveyor line 41 may be used for inbound storage, and the lower conveyor line 42 may be used for outbound delivery. As shown in FIG. 1, the circumferential shelf 20 may be provided with an opening (not shown), and the conveyor line 41 may be provided near the opening so as to facilitate the robot 30 to pick the containers on the conveyor line 41.

As shown in FIGS. 1 and 2, the storage system 100 also includes a container type identifying mechanism 50 for identifying the type of the container 10. The type of the container 10 may be determined based on the type of product contained in the container 10, and all containers 10 may be stacked together. The type of the container 10 may be represented by a barcode or QR code on the surface of the container 10. However, type of the container 10 may also be represented by any other identifier, such as a radio frequency label.

In some embodiment, the container type identifying mechanism 50 may be mounted at the upper conveyor line 41 such that when the container 10 is delivered to the circumferential shelf 20 during inbound storage, the type of the container 10 may be identified by the container type identifying mechanism 50 in advance. The identified type of the container 10 may be communicated to the controller 60.

All containers 10 of each type may be pre-determined by the controller 60 to be stored at certain locations of the circumferential shelf 20. The storage positions for each type of containers may be pre-determined based on the types of the containers and the number of the containers. For example, in the case that various types of containers will be handled by this system 100, the controller 60 may determine a certain number of storage positons for each type of containers, for example, and several storage racks 21 may be used to store one type of containers 10, and each storage rack 21 comprises a plurality of storage compartments 22, for example, 5 storage compartments as shown in FIG. 1.

When the robot 30 receives a container of a certain type, the controller 60 may command the robot 30 to place this container to one of the pre-determined and non-occupied storage position. After each container has been placed at the storage position, the controller 60 may update the occupancy status of the circumferential shelf 20, and the controller 60 may use the updated occupancy status to determine the target storage position(s) for the next container(s).

In some embodiments, the storage system 100 further includes a container loading mechanism 70 which may be provided near the end of the upper conveyor line 41, such that the containers 10 delivered on the conveyor line may be stacked by the container loading mechanism 70, and the stacked container may be stored as a whole into the shelf 20 so as to adapt to the peak business.

Sometimes, when the number of containers in the flow warehousing is not that large, the containers 10 can be delivered one by one with sufficient time interval between adjacent containers such that the robot 30 have sufficient time to operate the container 10 one by one. However, sometimes, the number of containers in the flow warehousing is quite large, the delivering time interval between adjacent containers is quite short and there is no enough time for the robot 30 to handle them one by one. In this case, the containers may be stacked together by the container loading mechanism 70 for warehousing. That is to say, several containers (for example, up to 5 containers) may be stacked together by the container loading mechanism 70 such that they may be delivered together. The maximum number of the stacked containers 10 should be less or equal to the maximum number of the containers that is supported by one storage compartment 22.

In some embodiments, the stacked containers 10 may be of same type for storing same type of products. For example, if the containers on the upper conveyor line 41 may be of same types, after obtaining the type of the containers 10, the controller 60 may communicate with the loading mechanism 70 such that the loading mechanism 70 may directly stack them together without sorting them out.

In some embodiments, the stacked containers 10 may be of different types for storing different types of products. For example, sometimes, when the number of containers in the flow warehousing is large, there is no time to handle individual container. In this case, the containers on the upper conveyor line 41 may be of different types, after obtaining the types of the containers 10, the controller 60 may communicate with the loading mechanism 70 to stack the containers up to the maximum number regardless of the types of the containers, and then the controller 60 may communicate with the robot 30 to place the stacked containers of different types to the same storage compartment 22 as a whole. Then, the picked and stacked containers of the certain type may be operated by the robot 30 as a whole. When the number of containers in in the flow warehousing is not large, for example, at night, the controller 60 may command the robot 30 to place the certain type of container to the right storage position predetermined by the controller 60. Since there is enough time at night, the robot 30 can sort the containers that are stacked together in the storage compartment at day time.

In addition to combine or stack several containers together as mentioned above, the container loading mechanism 70 may also unpack the stacked container into different group.

For example, sometimes, the containers 10 may be not delivered one by one, but delivered in a batch, that is to say, several containers of different types may be stacked and delivered together. After obtaining the type of the containers, the controller 60 may communicate with the loading mechanism 70 such that the loading mechanism 70 may sort the containers belonging to a certain type and pick them up, and the containers not belonging to this certain type may flow away directly so as to be operated by the robot 30, and then the containers belonging to this certain type may be operated as a whole by the robot 30. By including this loading mechanism 70, the stacked container of different types can be separated in advance based on the type of the container, thereby facilitating the robot 30 to operate several containers of the same type as a whole and avoiding stacking different types of containers together in a single storage compartment 22. In this way, it will reduce the workload of the robot 30 for placing the certain type of containers to the right place and improve the sorting efficiency at night.

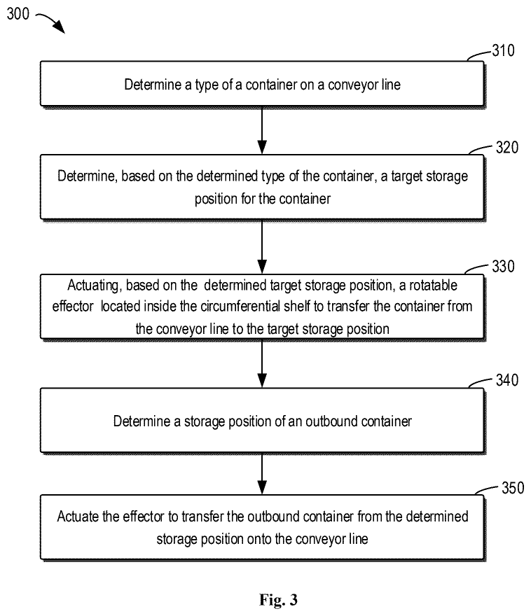

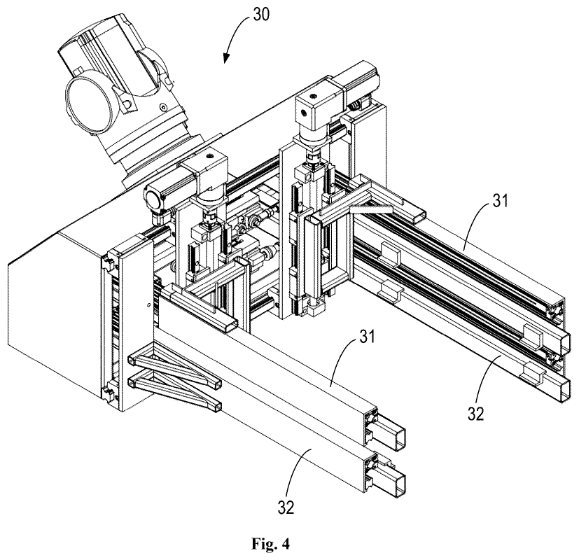

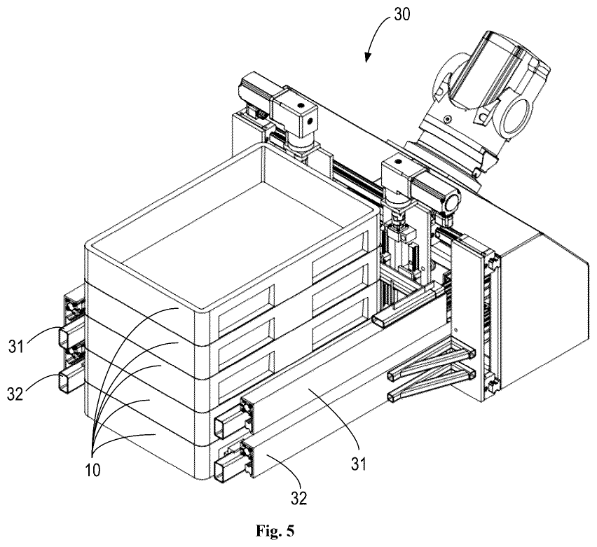

Hereinafter, the method for managing the product container according to some embodiments of the present disclosure will be described with reference to FIG. 3 to FIG. 5. FIG. 3 illustrates a flow chart 300 of managing the product container according to some embodiments of the present disclosure; FIG. 4 illustrates a perspective view of a flexible gripper of the robot according to some embodiments of the present disclosure; and FIG. 5 illustrates a perspective view of a flexible gripper of the robot and the containers housed therein according to some embodiments of the present disclosure.

As shown in FIG. 3, at step 310, the type of the container 10 on conveyor line is obtained, for example, from the container type identifying mechanism 50, which communicates the type of the container 10 to the controller 60. The type of the container 100 may be represented by a barcode on the surface thereof.

As shown in FIG. 3, at step 320, based on the determined type of the container, the target storage position for the container is determined by the controller 60. Specifically, the container may be one container, or a set of container of the same type. In this case, the set of containers of the same type may be stacked together by the container loading mechanism 70, and the storage positons for the set of containers can be determined as a whole. Further, if the set of containers of different types are stacked together when the number of containers to be handled is quite large, the set of stacked containers can be stored as a whole, and the storage positons for them can be determined as a whole.

Since the containers of different types are stacked in the same storage compartment, some of them may not be stored at the predetermined position predefined by the controller 60. The controller 60 may command the robot 30 to sort them at night when the containers are not transferred from the conveyor line 40 to the shelf 20. That is to say, the controller 60 may determine an updated storage position for each container among the set of containers of different types stacked in the same storage compartment, and command the effector 30 to move the target container to the updated storage position.

When determining the target storage positions for the containers 10 of the same type, the controller 60 may perform the following operation: determining predetermined storage positions on the circumferential shelf 20 that are predefined for all containers 10 of the determined type; obtaining a occupancy status of the predetermined storage positions; selecting a set of free storage positions among the plurality of free storage positions as target storage positions for a set of containers 10 of the same type.

When determining the target storage positions for the containers 10 of different types, the controller 60 may perform the following operation: obtaining a occupancy status of the circumferential shelf 20; determining, based on the occupancy status, a plurality of free storage positions 23; selecting a set of free storage positions 23 among the plurality of free storage positions as a set of preliminary target storage positions for the set of containers 10. The above steps can be operated by the controller 60 at day time when the number of containers to be handled is quite large. At night, when the container 10 is not transferred from the conveyor line 40 to the shelf 20, the controller 60 may perform the following operation: obtaining the type of a target container 10 located at a certain preliminary target storage position 23 among the set of preliminary target storage positions; and determining, based on the determined type of the target container 10, an updated target storage position 12 of the target container 10 on the circumferential shelf 20. The controller 60 may obtain the type of the target container by the effector 30 or may store the type of the target containers obtained by the container type identifying mechanism 50 at day time.

When determining the updated target storage position 23 for the target container 10 on the circumferential shelf 20, the controller 60 may perform the following operations: obtaining a occupancy status of the predetermined storage positions for all containers 10 of the determined type; determining, based on the occupancy status, a free storage position among the predetermined storage positions; and selecting the determined free storage position as the updated target storage position for the target container 10.

As shown in FIG. 3, at step 330, based on the determined target storage position, the controller 60 commands a rotatable effector 30 (such as, an industrial robot) located inside the circumferential shelf 20 to be actuated to transfer the container 10 to the determined target storage position.

In some embodiments, the container 10 is directly moved from the conveyor line 40 to the final target storage positon, when the target storage positon is one of the predetermined storage positions. In some embodiments, the container 10 is moved from the conveyor line 40 to the preliminary target storage position when the warehouse quantity is large, and then the container is moved from the preliminary target storage position to the updated target storage position when the robot is idle or there is no inbound and outbound task at night.

As shown in FIG. 3, in order to deliver out the required container according to the outbound order, the method 300 further comprises the step 340 of determining a storage position of an outbound container 10 according to the outbound order, and the step 350 of actuating the effector 30 to transfer the outbound container 10 from the determined storage positon onto the conveyor line 40.

Sometimes, a target container 10 to be moved is not located at a top storage position of the storage compartment 22. For the target container 10 to be moved, it may be the container to be moved to the updated target storage position or the container to be delivered out. In order to pick out the container at the middle of the storage compartment 22, the effector 30 may comprise a flexible gripper 31 as shown in FIG. 4 and FIG. 5.

As shown in FIG. 4 and FIG. 5, the flexible gripper 31 comprises an upper actuation mechanism 32 and a lower actuation mechanism 33. In one example, when the target container 10 at the middle storage positon is to be picked, for example, to be transferred to a right position or to be transferred to the conveyor line 40, the controller 60 may cause the flexible gripper 31 to perform the following operations: actuating the upper actuation mechanism 32 to lift one or more containers above the target container 10; actuating the lower actuation mechanism to pick the target container 10; actuating the upper actuation mechanism to place the one or more containers to original position; and actuating the lower actuation mechanism to transfer the target container 10 to the updated storage position 23 or to the conveyor line 40. Similarly, if the containers to be delivered out are located at the middle positions, the containers can be picked out according to above mentioned operations.

If the containers to be delivered out are located at top positions, the upper and lower actuation mechanisms 32 and 33 can be actuated respectively to pick out the containers 10 belonging to different types. By incorporating multi-layer actuation mechanisms 31 (for example, a flexible gripper) in the robot 30, the container of different types can be delivered out in any combination.

In the storage system 100 according to the present disclosure, with the cooperation of 6-axis robot and circumferential warehouse structure, it can implement the storage and scheduling of the containers (such as totes) for storing the products with a compact and reasonable layout and high efficiency. Since the robot 30 is located inside the circumferential shelf 20, for example, at a center of the shelf and the robot 30 can be rotated to fetch the containers at an opening of the circumferential shelf 20, there is no need for the robot to move between adjacent shelfs to fetch target containers, and only by the rotation of the robot, the flexible gripper 31 on the robot 30 can achieve each storage position, thus saving plenty of time for inbound and outbound operation of the containers. Therefore, by this kind of layout design, the storage system at least can improve space utilization, and achieve high throughput, and high warehouse efficiency.

The totes in the warehouse are filled with various products and are randomly fed from the conveyor line 40. At this time, the tote stacker (for example, the loading mechanism 70) stacks the same totes into 2 or 5, and enters the stacked totes to the warehouse together. The loading (for example, stacking and unpacking mechanism) mechanism 70 can stack the same type or different types of containers 10 together. Then, the robot 30 puts a stack of totes onto the shelf 20, and a single material tote flows away directly. Thus, the system 100 can realize the inbound operation of totes and incoming material combination with high efficiency. When the warehousing quantity is large, several totes can be warehoused together to improve the storage efficiency. Further, when the robot is idle or there is no inbound and outbound task at night, the totes of the same kind can be sorted in the warehouse to improve the utilization rate of the robot. Further, during inbound storage of the stacked containers on the conveyor line 40, by identifying the types of the containers, the controller 60 may command the loading mechanism 70 to separate stacked containers into different groups such that the same type of containers are grouped, the system 100 can achieve the incoming material sorting, and reduce the workload for the robot 30 to sort them at idle time (for example, at night).

Therefore, for peak business and idle time, by stacking various types of containers together and storing them as whole into the shelf and then sorting them out at night by the flexible gripper, the system 100 not only meets the normal operation of multiple peaks, but also ensures the utilization of idle time. Therefore, this design scheme has strong freedom and flexibility, achieving high throughput, high flexibility. Warehouse efficiency has been significantly improved, and labor and material costs has been reduced significantly.

Further, the intelligent sorting fixture or gripper 31 of the robot 30 has multi-layer grippers, and by actuating different grippers to move in the up and down direction and forward and backward direction, the grippers may grip different containers at different storage positions, even at middle storage positions. Thus, the system 100 may realize the combined outbound and inbound of any totes, sorting of stacked totes in the shelf according to any specific combinations, etc. Any combination of stock out is allowed. Any one tote or several totes on the upper layer can be delivered flexibly. It has faster sorting speed and strong flexibility and adaptability.

This storage system 100 is based on the unique advantages of high automation and flexibility of industrial robots 30. The storage system 100 has improvements at least in in warehouse layout design (for example, circumferential shelf 20 and centrally located robot 30), totes inbound and outbound scheduling (for example, by means of conveyor line 40), intelligent design of fixtures (for example, fixture gripper 31), thereby adapting to the complex stacking application environment of totes and customer needs. The storage system 100 has achieved high flexibility, small floor area, expandable and short deployment cycle, improved space utilization, and the integrated design of workstations of robots, intelligent fixtures (gripper) and stacking/unpacking mechanisms, which has improved the accuracy and efficiency of picking. Thus, this system 100 expands the application of “Flexbuffer”, not only improves the storage capacity, but also greatly improves the flexibility. It has not only the transportation function, but also the picking function, allowing flexible receipt and delivery management.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 3. Generally, program modules include routines, programs, libraries, objects, types, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of managing a container for storing products comprising:
determining a type of the container on a conveyor line;
determining, based on the determined type, a target storage position for the container on a circumferential shelf, wherein the circumferential shelf comprises a plurality of storage racks arranged in a circumferential shape, a storage rack among the plurality of storage racks comprises a plurality of storage compartments arranged in multiple layers, and a storage compartment among the plurality of storage compartments comprises at least one storage position configured to store at least one container; and
actuating, based on the determined target storage position, a rotatable effector located inside the circumferential shelf, to transfer the container from the conveyor line to the target storage position.

2. The method according to claim 1, wherein the type of the container is determined based on a type of the products stored in the container.

3. The method according to claim 1, wherein the container comprises one container or
wherein the container comprises a set of containers for storing same type of products, the set of containers being stacked together, and a number of the set of containers being less than or equal to a maximum number of containers that can be accommodated per storage compartment.

4. The method according to claim 3, wherein:
determining, based on the determined type, the target storage position for the container on the circumferential shelf comprises:
determining predetermined storage positions on the circumferential shelf that are predefined for containers of the determined type;
obtaining a occupancy status of the predetermined storage positions;
determining, based on the occupancy status, a plurality of free storage positions among the predetermined storage positions; and
selecting a set of free storage positions among the plurality of free storage positions as target storage positions for a corresponding number of containers.

5. The method according to claim 1, wherein:
the container comprises a set of containers for storing different types of products, the set of containers being stacked together, and a number of the set of containers being less than or equal to a maximum number of containers that can be accommodated per storage compartment,
determining, based on the determined type, the target storage position for the container on the circumferential shelf comprises:
obtaining a occupancy status of the circumferential shelf;
determining, based on the occupancy status, a plurality of free storage positions;
selecting a set of free storage positions among the plurality of free storage positions as a set of preliminary target storage positions for the set of containers;
obtaining the type of a target container located at a certain preliminary target storage position among the set of preliminary target storage positions; and
determining, based on the determined type of the target container, an updated target storage position of the target container on the circumferential shelf.

6. The method according to claim 5, wherein actuating, based on the determined target storage position, the rotatable effector located inside the circumferential shelf to transfer the container to the target storage position comprises:
actuating, based on the set of preliminary target storage positions, the effector to move the set of containers to the set of preliminary target storage positions; and
actuating, based on the determined updated target storage position, the effector to move the target container among the set of containers from the certain preliminary target storage position to the updated target storage position.

7. The method according to claim 5, wherein determining, based on the determined type of the target container, the updated target storage position of the target container on the circumferential shelf comprises:
determining predetermined storage positions on the circumferential shelf that are predefined for containers of the determined type;
obtaining a occupancy status of the predetermined storage positions;
determining, based on the occupancy status, a free storage position among the predetermined storage positions; and
selecting the determined free storage position as the updated target storage position for the target container.

8. The method according to claim 6, wherein the target container is located at a storage position other than a top storage position of the preliminary target storage positions, and the effector comprises a plurality of actuation mechanisms,
wherein based on the determined updated target storage position, actuating the effector to move the target container among the set of containers from the certain preliminary target storage position to the updated target storage position comprises:
actuating a first actuation mechanism of the plurality of actuation mechanisms to lift one or more containers above the target container;
actuating a second actuation mechanism of the plurality of actuation mechanisms to pick the target container;
actuating the first actuation mechanism to place the one or more containers to respective preliminary target storage positions; and
actuating the second actuation mechanism to transfer the target container from the certain preliminary target storage position to the updated target storage position.

9. The method according to claim 1, further comprising:
determining a storage position of an outbound container;
actuating the effector to transfer the outbound container from the determined storage position onto the conveyor line.

10. The method according to claim 9, wherein the effector comprises a plurality of actuation mechanisms and the outbound container is located at a storage position other than a top storage position of a respective storage compartment,
wherein actuating the effector to transfer the outbound container from the storage position onto the conveyor line comprises:
actuating a first actuation mechanism of the plurality of actuation mechanisms to lift one or more containers above the outbound container;
actuating a second actuation mechanism of the plurality of actuation mechanisms to pick the outbound container;
actuating the first actuation mechanism to place the one or more containers into the respective storage compartment; and
actuating the second actuation mechanism to transfer the outbound container from the storage position onto the conveyor line.

11. The method according to claim 9, wherein the effector comprises a plurality of actuation mechanisms, and the outbound container comprise a plurality of outbound containers belonging to different types,
wherein actuating the effector to transfer the outbound container from the storage position onto the conveyor line comprises:
actuating a first actuation mechanism of the plurality of actuation mechanisms to pick a first set of outbound containers belonging to a first type of the different types ;
actuating a second actuation mechanism of the plurality of actuation mechanisms to pick a second set of outbound containers belonging to a second type of the different types; and
actuating the plurality of actuation mechanisms to transfer the plurality of outbound containers to the conveyor line.

12. The method according to claim 1, wherein the effector comprises a robot located inside the circumferential shelf.

13. An electronic device comprising:
a processor; and
a memory coupled to the processor and comprising instructions that when executed by the processor, cause the processor to perform the method according to claim 1.

14. A storage system comprising:
a container for storing products, wherein a type of the container is determined based on the type of the products stored therein;
a circumferential shelf comprising a plurality of storage racks arranged in a circumferential shape, wherein a storage rack among the plurality of storage racks comprises a plurality of storage compartments arranged in multiple layers, and a storage compartment among the plurality of storage compartments comprises at least one storage position for storing at least one container;
a conveyor line located at an opening arranged on the circumferential shelf and configured to convey the container into or out of the circumferential shelf;
a rotatable effector located inside the circumferential shelf and configured to be actuated to transfer the container from one of the conveyor line and the circumferential shelf to the other of the conveyor line and the circumferential shelf; and
the electronic device according to claim 13.

15. The storage system according to claim 14, wherein the conveyor line comprises:
an inbound mechanism located at the opening and configured to convey the container towards the circumferential shelf;
an outbound mechanism located at the opening and configured to convey the container towards the conveyor line;
a container type identification mechanism located at the inbound mechanism and configured to identify a type of the container; and
a container loading mechanism for stacking and unpacking a set of containers on the inbound mechanism.

16. A computer readable storage medium comprising instructions stored thereon, which when executed on at least one processor, cause the at least one processor to perform the method according to claim 1.
